(19) United States
(12) Patent Application Publication
(10) Pub. No.: US 2015/0140440 A1
(43) Pub. Date: May 21, 2015

(54) METHOD FOR PREPARING POLYACRYLONITRILE-METHYL METHACRYLATE GEL ELECTROLYTE FILM, CORRESPONDING ELECTROLYTE AND PREPARATION METHOD THEREOF

(71) Applicants: Mingjie Zhou, Shenzhen (CN); Daxt Liu, Shenzhen (CN); Yaobing Wang, Shenzhen (CN)

(72) Inventors: Mingjie Zhou, Shenzhen (CN); Daxt Liu, Shenzhen (CN); Yaobing Wang, Shenzhen (CN)

(21) Appl. No.: 14/400,790

(22) PCT Filed: Jun. 29, 2012
(86) PCT No.: PCT/CN2012/077845

§ 371 Date: Nov. 12, 2014

(51) Int. Cl. H01M 10/0565; H01M 10/0525

(52) U.S. Cl. CPC H01M 10/0565; H01M 10/0525; H01M 2300/0082
USPC 429/303

(57) ABSTRACT

Provided is a method for preparing polyacrylonitrile-methyl methacrylate gel electrolyte film. The method comprises the following steps: dissolving polyacrylonitrile-methyl methacrylate in an organic solvent with the mass 1 to 3 times as high as that of polyacrylonitrile-methyl methacrylate, adding MCM-48 mesoporous molecular sieves with the mass 0.05 to 0.3 times as high as that of polyacrylonitrile-methyl methacrylate, heating the mixture to 30-50° C., stirring them uniformly, and obtaining a slurry containing MCM-48 mesoporous molecular sieve; coating the slurry onto the substrate, vacuum drying, and obtaining a mesoporous molecular sieve MCM-48 modified polyacrylonitrile-methyl methacrylate gel electrolyte film. In addition, the corresponding electrolyte and its preparation method are also provided. The polyacrylonitrile- methyl methacrylate gel electrolyte modified by mesoporous molecular sieve MCM-48 has high electrical conductivity and good security. The preparation method has simple technical process and is environment-friendly.

### FIELD OF THE INVENTION

The present invention relates to the field of electrochemistry, particularly to method for preparing polyacrylonitrile-methyl methacrylate gel electrolyte film, corresponding electrolyte and preparation method thereof.

### BACKGROUND OF THE INVENTION

With the development of new energy resources and growing demand for large-capacity and high-power chemical power supply of portable electronics and electric vehicle, it has become more important to develop a new battery material having high discharge rates. However, security is always a problem restricting the application of large-capacity and high-power lithium-ion battery. Major potential safety hazard of battery are electrolyte leakage, oxidation and decomposition of electrolyte, and combustion or explosions caused by thermal runaway.

Advantage of conventional liquid electrolyte is high conductivity. However, it contains flammable and volatile organic solvents, releasing combustible gas when charging and discharging. Specially, under unusual operating conditions (such as charging/discharge at high rates, overcharge and over discharge, etc.), large amounts of heat will accelerate production of gas, leading to increased pressure within the battery, gas leakage, even fire and explosion, so there is a serious security risk. Lithium-ion polymer batteries have attracted the attention of researchers due to its advantages of safe, no electrolyte leakage and low current leakage. Further, the research focus on gel solid polymer electrolytes, since the application of solid polymer electrolyte is restricted due to its low conductivity (10⁻⁵-10⁻⁴ s/cm) at room temperature.

### SUMMARY OF THE INVENTION

In view of this, the present invention aims to provide a method for preparing polyacrylonitrile-methyl methacrylate gel electrolyte film, corresponding electrolyte and preparation method thereof. After being modified by MCM-48 mesoporous molecular sieve, the polyacrylonitrile-methyl methacrylate gel electrolyte of the present invention has higher electrical conductivity and good security. Further, it can be used for lithium-ion batteries. Preparation method of the present invention has simple process and is environment-friendly.

In a first aspect, the present invention provides a method for preparing polyacrylonitrile-methyl methacrylate gel electrolyte film, comprising:

(1) dissolving polyacrylonitrile-methyl methacrylate in organic solvent in an amount ranging from 1 to 3 times the weight of polyacrylonitrile-methyl methacrylate, followed by adding MCM-48 mesoporous molecular sieves; elevating temperature to 30° C.-50° C. while stiffing thoroughly, then obtaining a slurry containing MCM-48 mesoporous molecular sieve; wherein mass ratio of MCM-48 mesoporous molecular sieve to polyacrylonitrile-methyl methacrylate is in a range of 0.05-0.3:1;

(2) applying the slurry to a substrate, followed by vacuum drying at 60° C.-100° C. for a period of 24 h-48 h; then obtaining a MCM-48 mesoporous molecular sieve modified polyacrylonitrile-methyl methacrylate gel electrolyte film.

The step (1) is a process of obtaining a slurry containing MCM-48 mesoporous molecular sieve by dissolving polyacrylonitrile-methyl methacrylate (P(AN-MMA)) in organic solvent.

Preferably, a mass-average molecular mass of polyacrylonitrile-methyl methacrylate is in a range of 100,000-500,000.

Preferably, organic solvent in step (1) is N-methylpyrrolidone, N,N-dimethylformamide, acetonitrile or ethanol.

Preferably, MCM-48 mesoporous molecular sieve is prepared by the following steps: dissolving cetyl trimethyl ammonium bromide in deionized water, followed by adding sodium hydroxide; elevating temperature to 20° C.-50° C., then stiffing thoroughly at a constant temperature to dissolve sodium hydroxide; adding 1.0 g of tetraethyl orthosilicate while stirring for a period of 4-5 h, then obtaining liquid reactant; transferring the liquid reactant to a polytetrafluoroethylene-lined reactor, then standing and crystallizing in a drying oven at 100° C.; filtrating and washing with water, then drying at 70° C.-90° C. for a period of 12-48 h to obtain MCM-48 precursor; placing the MCM-48 precursor in a muffle furnace, followed by roasting at 500° C.-600° C. for a period of 4-10 h to remove template, then obtaining MCM-48 mesoporous molecular sieve; wherein mass ratio of deionized water to sodium hydroxide to tetraethyl orthosilicate is in a range of 60-80:0.3-0.6:1, and mass ratio of cetyl trimethyl ammonium bromide to deionized water in a range of 0.8%-1.2%.

Preferably, pore size of MCM-48 mesoporous molecular sieve is in a range of 2-5 nm.

Introduction of MCM-48 mesoporous molecular sieve renders the obtained polyacrylonitrile-methyl methacrylate gel electrolyte film with good porous structure, where there are not only a large number of pores on the surface, but many interconnected pores beneath the surface. Such porous structure will improve the conductivity of the electrolyte.

The step (2) is a process of transferring the obtained slurry and preparing MCM-48 mesoporous molecular sieve modified polyacrylonitrile-methyl methacrylate gel electrolyte film.

Specifically, the slurry is applied to a substrate, followed by vacuum drying at 60° C.-100° C. for a period of 24 h-48 h; then a dried MCM-48 mesoporous molecular sieve modified polyacrylonitrile-methyl methacrylate gel electrolyte film is obtained. Presence of a large number of pores in film is beneficial to conductivity of electrolyte.

Preferably, a thickness of polyacrylonitrile-methyl methacrylate gel electrolyte film is in a range of 30 μm-50 μm.

Preferably, the substrate is glass plate or polytetrafluoroethylene plate.

In a second aspect, the present invention provides a method for preparing polyacrylonitrile-methyl methacrylate gel electrolyte, comprising:

(1) dissolving polyacrylonitrile-methyl methacrylate in organic solvent in an amount ranging from 1 to 3 times the weight of polyacrylonitrile-methyl methacrylate, followed by adding MCM-48 mesoporous molecular sieves; elevating temperature to 30° C.-50° C. while stirring thoroughly, then obtaining a slurry containing MCM-48 mesoporous molecular sieve; wherein mass ratio of MCM-48 mesoporous molecular sieve to polyacrylonitrile-methyl methacrylate is in a range of 0.05-0.3:1;

(2) applying the slurry to a substrate, followed by vacuum drying at 60° C.-100° C. for a period of 24 h-48 h; then obtaining a MCM-48 mesoporous molecular sieve modified polyacrylonitrile-methyl methacrylate gel electrolyte film;

(3) in a glove box filled with inert gas, immersing the polyacrylonitrile-methyl methacrylate gel electrolyte film in electrolyte for a period of 5 min-60 min, then obtaining a MCM-48 mesoporous molecular sieve modified polyacrylonitrile-methyl methacrylate gel electrolyte.

The step (1) is a process of obtaining a slurry containing MCM-48 mesoporous molecular sieve by dissolving polyacrylonitrile-methyl methacrylate (P(AN-MMA)) in organic solvent.

Preferably, a mass-average molecular mass of polyacrylonitrile-methyl methacrylate is in a range of 100,000-500,000.

Preferably, organic solvent in step (1) is N-methylpyrrolidone, N,N-dimethylformamide, acetonitrile or ethanol.

Preferably, MCM-48 mesoporous molecular sieve is prepared by the following steps: dissolving cetyl trimethyl ammonium bromide in deionized water, followed by adding sodium hydroxide; elevating temperature to 20° C.-50° C., then stiffing thoroughly at a constant temperature to dissolve sodium hydroxide; adding 1.0 g of tetraethyl orthosilicate while stirring for a period of 4-5 h, then obtaining liquid reactant; transferring the liquid reactant to a polytetrafluoroethylene-lined reactor, then standing and crystallizing in a drying oven at 100° C.; filtrating and washing with water, then drying at 70° C.-90° C. for a period of 12-48 h to obtain MCM48 precursor; placing the MCM-48 precursor in a muffle furnace, followed by roasting at 500° C.-600° C. for a period of 4-10 h to remove template, then obtaining MCM-48 mesoporous molecular sieve; wherein mass ratio of deionized water to sodium hydroxide to tetraethyl orthosilicate is in a range of 60-80:0.3-0.6:1, and mass ratio of cetyl trimethyl ammonium bromide to deionized water in a range of 0.8%-1.2%.

Preferably, pore size of MCM-48 mesoporous molecular sieve is in a range of 2-5 nm.

Introduction of MCM-48 mesoporous molecular sieve renders the obtained polyacrylonitrile-methyl methacrylate gel electrolyte film with good porous structure, where there are not only a large number of pores on the surface, but many interconnected pores beneath the surface. Such porous structure will improve the conductivity of the electrolyte.

The step (2) is a process of transferring the obtained slurry and preparing MCM-48 mesoporous molecular sieve modified polyacrylonitrile-methyl methacrylate gel electrolyte film.

Specifically, the slurry is applied to a substrate, followed by vacuum drying at 60° C.-100° C. for a period of 24 h-48 h; then a dried MCM-48 mesoporous molecular sieve modified polyacrylonitrile-methyl methacrylate gel electrolyte film is obtained. Presence of a large number of pores in film is beneficial to conductivity of electrolyte.

Preferably, a thickness of polyacrylonitrile-methyl methacrylate gel film is in a range of 30 μm-50 μm.

Preferably, the substrate is glass plate or polytetrafluoroethylene plate.

The step (3) is a process of preparing polyacrylonitrile-methyl methacrylate gel electrolyte by immersing the obtained polyacrylonitrile-methyl methacrylate gel electrolyte film in electrolyte.

Preferably, the electrolyte consists of LiPF₆, EC and DMC.

Preferably, mass ratio of EC to DMC is in a range of 1:3-2:1.

Preferably, molar concentration of LiPF₆ is in a range of 0.5-1.5 mol/L.

Preferably, electrolyte is contained in a glove box filled with inert gas.

Electrolyte is contained in a glove box filled with inert gas.

Preferably, inert gas is nitrogen gas or argon gas.

In a third aspect, the present invention provides a polyacrylonitrile-methyl methacrylate gel electrolyte prepared by methods as set forth above.

The present invention provides method for preparing polyacrylonitrile-methyl methacrylate gel electrolyte film, corresponding electrolyte and preparation method thereof. The present invention has the following advantages:

(1) After being modified by MCM-48 mesoporous molecular sieve, the polyacrylonitrile-methyl methacrylate gel electrolyte of the present invention has higher electrical conductivity, good security, better power density, long lifetime and larger capacity;

(2) The method for preparing polyacrylonitrile-methyl methacrylate gel electrolyte of the present invention has simple process and is low-cost and environment-friendly.

(3) The polyacrylonitrile-methyl methacrylate gel electrolyte of the present invention has can be used for lithium-ion batteries.

### DETAILED DESCRIPTION OF ILLUSTRATED EMBODIMENTS

The invention will now be described in detail on the basis of preferred embodiments. It is to be understood that various changes may be made without departing from the spirit and scope of the inventions.

### Example 1

A method for preparing polyacrylonitrile-methyl methacrylate gel electrolyte comprises the following steps.

(1) 10 g of polyacrylonitrile-methyl methacrylate having a mass-average molecular mass of 300,000 were dissolved in 20 g of N-methylpyrrolidone (NMP), followed by adding 1.0 g of MCM-48 mesoporous molecular sieve. The mixture was thoroughly stirred, while the temperature was elevated to 30° C. Slurry containing MCM-48 mesoporous molecular sieve was obtained.

In this embodiment, MCM-48 mesoporous molecular sieve was prepared by the following steps: dissolving 0.6 g of CTAB (cetyl trimethyl ammonium bromide) in 65 mL of deionized water, followed by adding 0.47 g of sodium hydroxide; elevating temperature to 20° C., then stirring thoroughly at a constant temperature to dissolve sodium hydroxide; adding 1.0 g of tetraethyl orthosilicate while stirring for 4 h, then obtaining liquid reactant; transferring the liquid reactant to a polytetrafluoroethylene-lined reactor, then standing and crystallizing in a drying oven at 100° C.; filtrating and washing with water, then drying at 70° C. for 48 h to obtain MCM-48 precursor; placing the MCM-48 precursor in a muffle furnace, and elevating temperature at a speed of 5° C./min, then roasting the MCM-48 precursor at 500° C. for 10 h to remove template, then obtaining MCM-48 mesoporous molecular sieve.

(2) Slurry was applied to a glass plate, followed by vacuum drying at 60° C. for 48 h, then a MCM-48 mesoporous molecular sieve modified polyacrylonitrile-methyl methacrylate gel electrolyte film was obtained.

Specifically, in this embodiment, thickness of the polyacrylonitrile-methyl methacrylate gel electrolyte film was 45 μm.

(3) in a glove box filled with argon gas, the MCM-48 mesoporous molecular sieve modified polyacrylonitrile-methyl methacrylate gel electrolyte film was immersed in electrolyte for 5 min, then a MCM-48 mesoporous molecular sieve modified polyacrylonitrile-methyl methacrylate gel electrolyte was obtained.

Specifically, in this embodiment, electrolyte consists of LiPF₆, EC and DMC; mass ratio of EC to DMC was 1:1, and molar concentration of the LiPF₆ was 1 mol/L. Electrolyte was contained in a glove box filled with argon gas.

Conductivity of the MCM-48 mesoporous molecular sieve modified polyacrylonitrile-methyl methacrylate gel electrolyte of the present invention was 5.5 ms/cm.

Measurement of conductivity: Electrolyte was provided between two stainless electrodes to form a polymer electrolyte electrode system. Alternating current resistance was measured and a graphical representation of the complex impedance plane was produced. The intersection of the curve and the horizontal axis in high frequency region is bulk resistance. The bulk resistance (R_{b}) and ionic conductivity (σ) are related by

σ=d/(S*R_{b})

where d is thickness of polymer electrolyte film, and S is contact area between polymer electrolyte film and electrodes. Thus ionic conductivity can be calculated.

The prepared polyacrylonitrile-methyl methacrylate gel electrolyte was assembled into lithium-ion battery. 9.0 g of LiMn₂O₄, 0.45 g of acetylene black, 0.45 g of PVDF and 20 g of NMP were mixed and stirred thoroughly to form slurry. The slurry was applied to a aluminum foil which was cleaned with ethanol in advance, then drying to constant weight at 80° C. under a vacuum of 0.01 MPa, followed by rolling at a pressure of 10-15 MPa to produce LiMn₂O₄ electrode which was then cut into anode wafers. Lithium wafer was used as cathode. The prepared polyacrylonitrile-methyl methacrylate gel electrolyte was placed between electrodes as separator, and then sealed on a punching machine to prepare bottom battery. In a pressure range of 2.5-4.2V, the lithium-ion battery assembled according to this embodiment was tested at 0.1 C on a charge-discharge tester. The third discharge specific capacity was 105 mAh/g, and discharge efficiency was 96%.

To further illustrate advantages of the present invention, a comparative embodiment is provided below.

10 g of polyacrylonitrile-methyl methacrylate having a mass-average molecular mass of 300,000 were dissolved in 20 g of N-methylpyrrolidone (NMP). The mixture was thoroughly stirred, while the temperature was elevated to 30° C. Slurry was obtained. The slurry was applied to a clean glass plate, followed by vacuum drying at 60° C. under a vacuum of 0.01 MPa, and then a polyacrylonitrile-methyl methacrylate gel film having a thickness of 45 μm was obtained. The dried polyacrylonitrile-methyl methacrylate gel film was placed in a glove box filled with argon gas, then immersed in 1 mol/L of LiPF₆/EC+DMC (mass ratio 1:1) electrolyte for 5 min. polyacrylonitrile-methyl methacrylate gel electrolyte was obtained.

Test result shows that, conductivity of the polyacrylonitrile-methyl methacrylate gel electrolyte according to the comparative embodiment is only 1.3 ms/cm. Thus it can be seen that modification by MCM-48 mesoporous molecular sieve renders gel electrolyte with higher conductivity.

### Example 2

A method for preparing polyacrylonitrile-methyl methacrylate gel electrolyte comprises the following steps.

(1) 10 g of polyacrylonitrile-methyl methacrylate having a mass-average molecular mass of 100,000 were dissolved in 10 g of N,N-dimethylformamide, followed by adding 0.5 g of MCM-48 mesoporous molecular sieve. The mixture was thoroughly stirred, while the temperature was elevated to 40° C. Slurry containing MCM-48 mesoporous molecular sieve was obtained.

In this embodiment, MCM-48 mesoporous molecular sieve was prepared by the following steps: dissolving 0.48 g of CTAB (cetyl trimethyl ammonium bromide) in 60 mL of deionized water, followed by adding 0.3 g of sodium hydroxide; elevating temperature to 30° C., then stirring thoroughly at a constant temperature to dissolve sodium hydroxide; adding 1.0 g of tetraethyl orthosilicate while stirring for 4 h, then obtaining liquid reactant; transferring the liquid reactant to a polytetrafluoroethylene-lined reactor, then standing and crystallizing in a drying oven at 100° C.; filtrating and washing with water, then drying at 80° C. for 36 h to obtain MCM-48 precursor; placing the MCM-48 precursor in a muffle furnace, and elevating temperature at a speed of 5° C./min, then roasting the MCM-48 precursor at 500° C. for 8 h to remove template, then obtaining MCM-48 mesoporous molecular sieve.

(2) Slurry was applied to a glass plate, followed by vacuum drying at 80° C. for 36 h, then a MCM-48 mesoporous molecular sieve modified polyacrylonitrile-methyl methacrylate gel electrolyte film was obtained.

Specifically, in this embodiment, thickness of the polyacrylonitrile-methyl methacrylate gel electrolyte film was 35 μm.

(3) in a glove box filled with argon gas, the MCM-48 mesoporous molecular sieve modified polyacrylonitrile-methyl methacrylate gel film was immersed in electrolyte for 20 min, then a MCM-48 mesoporous molecular sieve modified polyacrylonitrile-methyl methacrylate gel electrolyte was obtained.

Specifically, in this embodiment, electrolyte consists of LiPF₆, EC and DMC; mass ratio of EC to DMC was 1:3, and molar concentration of the LiPF₆ was 0.5 mol/L. Electrolyte was contained in a glove box filled with argon gas.

Conductivity of the MCM-48 mesoporous molecular sieve modified polyacrylonitrile-methyl methacrylate gel electrolyte of the present invention was 4.2 ms/cm.

The prepared polyacrylonitrile-methyl methacrylate gel electrolyte was use to assemble into lithium-ion battery (in a corresponding manner as described in Example 1). In a pressure range of 2.5-4.2V, the lithium-ion battery assembled according to this embodiment was tested at 0.1 C on a charge-discharge tester. The third discharge specific capacity was 103 mAh/g, and discharge efficiency was 95%.

### Example 3

A method for preparing polyacrylonitrile-methyl methacrylate gel electrolyte comprises the following steps.

(1) 10 g of polyacrylonitrile-methyl methacrylate having a mass-average molecular mass of 500,000 were dissolved in 30 g of acetonitrile, followed by adding 2.0 g of MCM-48 mesoporous molecular sieve. The mixture was thoroughly stirred, while the temperature was elevated to 45° C. Slurry containing MCM-48 mesoporous molecular sieve was obtained.

In this embodiment, MCM-48 mesoporous molecular sieve was prepared by the following steps: dissolving 0.96 g of CTAB (cetyl trimethyl ammonium bromide) in 80 mL of deionized water, followed by adding 0.60 g of sodium hydroxide; elevating temperature to 40° C., then stirring thoroughly at a constant temperature to dissolve sodium hydroxide; adding 1.0 g of tetraethyl orthosilicate while stirring for 5 h, then obtaining liquid reactant; transferring the liquid reactant to a polytetrafluoroethylene-lined reactor, then standing and crystallizing in a drying oven at 100° C.; filtrating and washing with water, then drying at 90° C. for 24 h to obtain MCM-48 precursor; placing the MCM-48 precursor in a muffle furnace, and elevating temperature at a speed of 5° C./min, then roasting the MCM-48 precursor at 600° C. for 6 h to remove template, then obtaining MCM-48 mesoporous molecular sieve.

(2) Slurry was applied to a glass plate, followed by vacuum drying at 90° C. for 30 h, then a MCM-48 mesoporous molecular sieve modified polyacrylonitrile-methyl methacrylate gel film was obtained.

Specifically, in this embodiment, thickness of the polyacrylonitrile-methyl methacrylate gel film was 50 μm.

(3) in a glove box filled with nitrogen gas, the MCM-48 mesoporous molecular sieve modified polyacrylonitrile-methyl methacrylate gel film was immersed in electrolyte for 40 min, then a MCM-48 mesoporous molecular sieve modified polyacrylonitrile-methyl methacrylate gel electrolyte was obtained.

Specifically, in this embodiment, electrolyte consists of LiPF₆, EC and DMC; mass ratio of EC to DMC was 2:1, and molar concentration of the LiPF₆ was 1.5 mol/L. Electrolyte was contained in a glove box filled with nitrogen gas.

Conductivity of the MCM-48 mesoporous molecular sieve modified polyacrylonitrile-methyl methacrylate gel electrolyte of the present invention was 4.7 ms/cm.

The prepared polyacrylonitrile-methyl methacrylate gel electrolyte was use to assemble into lithium-ion battery (in a corresponding manner as described in Example 1). In a pressure range of 2.5-4.2V, the lithium-ion battery assembled according to this embodiment was tested at 0.1 C on a charge-discharge tester. The third discharge specific capacity was 100 mAh/g, and discharge efficiency was 93%.

### Example 4

A method for preparing polyacrylonitrile-methyl methacrylate gel electrolyte comprises the following steps.

(1) 10 g of polyacrylonitrile-methyl methacrylate having a mass-average molecular mass of 300,000 were dissolved in 30 g of ethanol, followed by adding 3.0 g of MCM-48 mesoporous molecular sieve. The mixture was thoroughly stirred, while the temperature was elevated to 50° C. Slurry containing MCM-48 mesoporous molecular sieve was obtained.

In this embodiment, MCM-48 mesoporous molecular sieve was prepared by the following steps: dissolving 0.85 g of CTAB (cetyl trimethyl ammonium bromide) in 80 g of deionized water, followed by adding 0.5 g of sodium hydroxide; elevating temperature to 50° C., then stirring thoroughly at a constant temperature to dissolve sodium hydroxide; adding 1.0 g of tetraethyl orthosilicate while stirring for 5 h, then obtaining liquid reactant; transferring the liquid reactant to a polytetrafluoroethylene-lined reactor, then standing and crystallizing in a drying oven at 100° C.; filtrating and washing with water, then drying at 90° C. for 12 h to obtain MCM-48 precursor; placing the MCM-48 precursor in a muffle furnace, and elevating temperature at a speed of 5° C./min, then roasting the MCM-48 precursor at 600° C. for 4 h to remove template, then obtaining MCM-48 mesoporous molecular sieve.

(2) Slurry was applied to a glass plate, followed by vacuum drying at 100° C. for 24 h, then a MCM-48 mesoporous molecular sieve modified polyacrylonitrile-methyl methacrylate gel film was obtained.

Specifically, in this embodiment, thickness of the polyacrylonitrile-methyl methacrylate gel film was 30 μm.

(3) in a glove box filled with argon gas, the MCM-48 mesoporous molecular sieve modified polyacrylonitrile-methyl methacrylate gel film was immersed in electrolyte for 60 min, then a MCM-48 mesoporous molecular sieve modified polyacrylonitrile-methyl methacrylate gel electrolyte was obtained.

Specifically, in this embodiment, electrolyte consists of LiPF₆, EC and DMC; mass ratio of EC to DMC was 1:2, and molar concentration of the LiPF₆ was 0.8 mol/L. Electrolyte was contained in a glove box filled with argon gas.

Conductivity of the MCM-48 mesoporous molecular sieve modified polyacrylonitrile-methyl methacrylate gel electrolyte of the present invention was 5.1 ms/cm.

The prepared polyacrylonitrile-methyl methacrylate gel electrolyte was use to assemble into lithium-ion battery (in a corresponding manner as described in Example 1). In a pressure range of 2.5-4.2V, the lithium-ion battery assembled according to this embodiment was tested at 0.1 C on a charge-discharge tester. The third discharge specific capacity was 98 mAh/g, and discharge efficiency was 92%.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

1. A method for preparing polyacrylonitrile-methyl methacrylate gel electrolyte film, comprising:
(1) dissolving polyacrylonitrile-methyl methacrylate in organic solvent in an amount ranging from 1 to 3 times the weight of polyacrylonitrile-methyl methacrylate, followed by adding MCM-48 mesoporous molecular sieves; elevating temperature to 30° C.-50° C. while stirring thoroughly, then obtaining a slurry containing MCM-48 mesoporous molecular sieve; wherein mass ratio of MCM-48 mesoporous molecular sieve to polyacrylonitrile-methyl methacrylate is in a range of 0.05-0.3:1;
(2) applying the slurry to a substrate, followed by vacuum drying at 60° C.-100° C. for a period of 24 h-48 h; then obtaining a MCM-48 mesoporous molecular sieve modified polyacrylonitrile-methyl methacrylate gel electrolyte film.

2. The method for preparing polyacrylonitrile-methyl methacrylate gel electrolyte film according to claim 1, wherein a mass-average molecular mass of the polyacrylonitrile-methyl methacrylate is in a range of 100,000-500,000.

3. The method for preparing polyacrylonitrile-methyl methacrylate gel electrolyte film according to claim 1, wherein the organic solvent in step (1) is N-methylpyrrolidone, N,N-dimethylformamide, acetonitrile or ethanol.

4. The method for preparing polyacrylonitrile-methyl methacrylate gel electrolyte film according to claim 1, wherein MCM-48 mesoporous molecular sieve is prepared by the following steps:
dissolving cetyl trimethyl ammonium bromide in deionized water, followed by adding sodium hydroxide; elevating temperature to 20° C.-50° C., then stirring thoroughly at a constant temperature to dissolve sodium hydroxide; adding tetraethyl orthosilicate while stirring for a period of 4-5 h, then obtaining liquid reactant;
transferring the liquid reactant to a polytetrafluoroethylene-lined reactor, then standing and crystallizing in a drying oven at 100° C.; filtrating and washing with water, then drying at 70° C.-90° C. for a period of 12-48 h to obtain MCM-48 precursor;
placing the MCM-48 precursor in a muffle furnace, followed by roasting at 500° C.-600° C. for a period of 4-10 h to remove template, then obtaining MCM-48 mesoporous molecular sieve;
wherein mass ratio of deionized water to sodium hydroxide to tetraethyl orthosilicate is in a range of 60-80:0.3-0.6:1, and mass ratio of cetyl trimethyl ammonium bromide to deionized water in a range of 0.8%-1.2%.

5. The method for preparing polyacrylonitrile-methyl methacrylate gel electrolyte film according to claim 1, wherein a thickness of the polyacrylonitrile-methyl methacrylate gel electrolyte film in step (2) is in a range of 30 μm-50 μm.

6. A method for preparing polyacrylonitrile-methyl methacrylate gel electrolyte, comprising:
(1) dissolving polyacrylonitrile-methyl methacrylate in organic solvent in an amount ranging from 1 to 3 times the weight of polyacrylonitrile-methyl methacrylate, followed by adding MCM-48 mesoporous molecular sieves; elevating temperature to 30° C.-50° C. while stirring thoroughly, then obtaining a slurry containing MCM-48 mesoporous molecular sieve; wherein mass ratio of MCM-48 mesoporous molecular sieve to polyacrylonitrile-methyl methacrylate is in a range of 0.05-0.3:1;
(2) applying the slurry to a substrate, followed by vacuum drying at 60° C.-100° C. for a period of 24 h-48 h; then obtaining a MCM-48 mesoporous molecular sieve modified polyacrylonitrile-methyl methacrylate gel electrolyte film;
(3) in a glove box filled with inert gas, immersing the polyacrylonitrile-methyl methacrylate gel electrolyte film in electrolyte for a period of 5 min-60 min, then obtaining a MCM-48 mesoporous molecular sieve modified polyacrylonitrile-methyl methacrylate gel electrolyte.

7. The method for preparing polyacrylonitrile-methyl methacrylate gel electrolyte according to claim 1, wherein the electrolyte in step (3) consists of LiPF₆, EC and DMC; mass ratio of EC to DMC is in a range of 1:3-2:1, and molar concentration of the LiPF₆ is in a range of 0.5 mol/L-1.5 mol/L.

8. The method for preparing polyacrylonitrile-methyl methacrylate gel electrolyte according to claim 1, wherein the organic solvent in step (1) is N-methylpyrrolidone, N,N-dimethylformamide, acetonitrile or ethanol.

9. The method for preparing polyacrylonitrile-methyl methacrylate gel electrolyte according to claim 1, wherein MCM-48 mesoporous molecular sieve is prepared by the following steps:
dissolving cetyl trimethyl ammonium bromide in deionized water, followed by adding sodium hydroxide; elevating temperature to 20° C.-50° C., then stirring thoroughly at a constant temperature to dissolve sodium hydroxide; adding tetraethyl orthosilicate while stirring for a period of 4-5 h, then obtaining liquid reactant;
transferring the liquid reactant to a polytetrafluoroethylene-lined reactor, then standing and crystallizing in a drying oven at 100° C.; filtrating and washing with water, then drying at 70° C.-90° C. for a period of 12-48 h to obtain MCM-48 precursor;
placing the MCM-48 precursor in a muffle furnace, followed by roasting at 500° C.-600° C. for a period of 4-10 h to remove template, then obtaining MCM-48 mesoporous molecular sieve;
wherein mass ratio of deionized water to sodium hydroxide to tetraethyl orthosilicate is in a range of 60-80:0.3-0.6:1, and mass ratio of cetyl trimethyl ammonium bromide to deionized water is in a range of 0.8%-1.2%.

10. A polyacrylonitrile-methyl methacrylate gel electrolyte prepared by the method according to claim 6.
